(19) United States
(12) Patent Application Publication
(10) Pub. No.: US 2020/0217135 A1
(43) Pub. Date: Jul. 9, 2020

(54) LADDER WEIGHT

(71) Applicant: Kurt A. Heiss, Lacona, IA (US)

(72) Inventor: Kurt A. Heiss, Lacona, IA (US)

(21) Appl. No.: 16/822,192

(22) Filed: Mar. 18, 2020

Related U.S. Application Data
(63) Continuation of application No. 16/015,487, filed on Jun. 22, 2018.
(60) Provisional application No. 62/523,340, filed on Jun. 22, 2017.

(51) Int. Cl. E06C 7/00; E06C 7/18

(52) U.S. Cl. CPC E06C 7/00; E06C 7/188

(57) ABSTRACT

A ladder weight having an elongated weighted member with a pair of parallel spaced arms attached to and extending upwardly from the elongated weighted member. The pair of arms terminate in a hooked portion adapted to receive a rung of the ladder. The arms and the hook portion have holes that are aligned to receive a bolt to secure the ladder weight to the rung of the ladder.

### CROSS REFERENCE TO RELATED APPLICATION

This application is a continuation application of U.S. Ser. No. 16/015,487 filed Jun. 22, 2018 which claims the benefit of the priority of U.S. Provisional Application No. 62/523,340 filed Jun. 22, 2017, the contents of these applications are hereby incorporated by reference in their entirety.

### BACKGROUND OF THE INVENTION

This invention is directed to a weight for a ladder and more particularly a weight that stabilizes to the bottom of a ladder during use.

Ladders are well-known in the art and provide many safety hazards. One hazard has to do with the stability of the ladder particularly when an individual is at the top of the ladder. To help stabilize the ladder a second individual stands at the bottom of the ladder and holds the ladder to prevent the ladder from moving and/or tipping.

While helpful, this process is labor intensive requiring a second individual. Often, a second individual is not available. Other attempts have been made to improve safety, but these devices focus on how the top portion of a ladder engages a structure, and not providing stability at the bottom. Therefore, a need exists in the art for a device that addresses these needs.

An objective of the present invention is to provide a weight for a ladder that improves safety and stability.

Another objective of the present invention is to provide a weight for a ladder that eliminates the need for a person to manually stabilize the ladder.

These and other objectives will be apparent to those having ordinary skill in the art based upon the following written description, drawings, and claims.

### SUMMARY OF THE INVENTION

A weight for a ladder includes an elongated weighted member having a top, a bottom, sides, and ends. Attached to the top of the elongated member is a handle. Attached to and extending upwardly from the weighted member are a pair of parallel spaced arms. The arms terminate in a hooked portion that is adapted to receive a rung of a ladder.

The arms and the hooked portion have holes that are aligned to secure the weight around the rung of the ladder. When attached, the elongated member provides the necessary weight to stabilize the ladder.

### BRIEF DESCRIPTION OF THE DRAWINGS

FIG. 1 is a perspective view of a weight for a ladder;

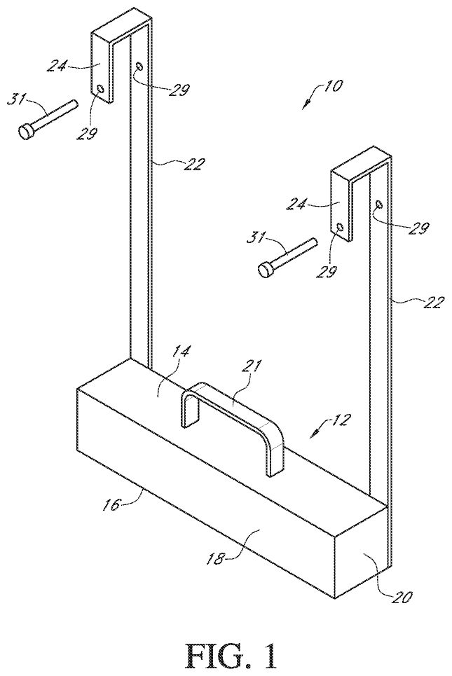

FIG. 2 is a front view of a weight for a ladder; and

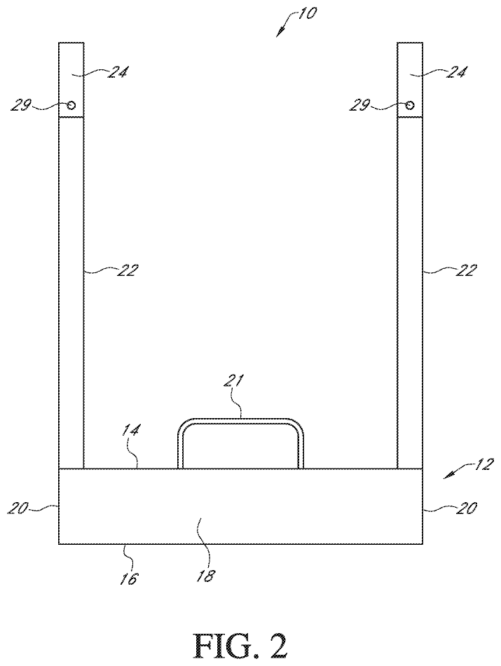

FIG. 3 is a perspective view of a ladder weight attached to a ladder.

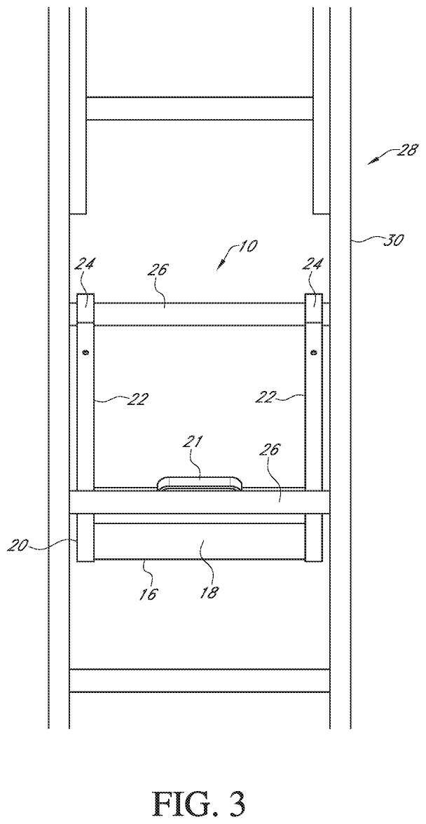

### DETAILED DESCRIPTION

Referring to the Figures, a ladder weight 10 includes an elongated weighted member or block 12. The weighted member 12 is of any size, shape, and structure. In the example shown, the weighted member 12 is rectangular in shape having a top 14, a bottom 16, sides 18, and ends 20. To assist in lifting and transporting the ladder weight 10, a handle 21 is attached or welded to the weighted member 12.

Extending upwardly from the weighted member 12 are a pair of parallel spaced arms 22. In a preferred example, the arms 22 are vertically flush with one of the sides 18 of the weighted member 12. The arms 22 extend vertically from the weighted member 12 and terminate in a hook portion 24. The hook portion 24 is of any size, shape, and structure and preferably is formed in a C-shape to receive a rung 26 on a ladder 28. In one example, the hook portion 24 and arms have holes 29 that align to receive a nut and bolt 31 to secure the weight around a ladder rung.

The length of the weighted member 12 and the space between the arms 22 is preferably less than the space between the support members 30 of the ladder 28 and no longer than the rungs 26. The length of the arms 22 preferably is greater than the vertical space between adjacent rungs 26.

In operation, the ladder 28 is placed against a structure at an angle where the top of the ladder 28 engages the structure and the bottom of the ladder 28 is spaced away from the structure. Next, the ladder weight 10 is attached to the ladder 28. More specifically, as the hook portion 24 is placed on a first or top rung the arms 22 and weighted portion is inserted through an opening 32 formed by adjacent rungs 26 and support members 30. As a result, once put in place, force from the hook portion 24 is applied to one side of the ladder 28 while force from the arms 22 and/or weighted member 12 are applied to the opposite side of the ladder 28 to stabilize the bottom of the ladder 28 for a user.

From the above discussion and accompanying figures and claims it will be appreciated that the ladder weight 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A ladder weight, comprising:
an elongated weighted member having a top, a bottom, sides, and ends;
a pair of arms in spaced parallel relation are flush with one of the sides of the elongated member and extend upwardly from the elongated member and terminate in a hook portion adapted to receive a rung of a ladder; and
wherein when the hook portion is placed on the rung of the ladder, the weighted portion is inserted through an opening formed by an adjacent rung and support members, force from the hook portion is applied to one side of the ladder while force from the arms and elongated weighted member are applied to an opposite side of the ladder to stabilize a bottom of the ladder.

2. The ladder weight of claim 1 wherein the hook portion is formed in a C-shape.

3. The ladder weight of claim 1 wherein the hook portions and the arms have holes that align to receive a bolt to secure the elongated weight member around the ladder rung.

4. The ladder weight of claim 1 further comprising a handle welded to the top of the elongated welded member.

5. The ladder weight of claim 1 wherein a length of the weighted member and the space between the pair of arms is less than a space between support members of the ladder.

6. The ladder weight of claim 1 wherein a length of the pair of arms is greater than a vertical space between adjacent rungs of the ladder.
